(19) United States
(12) Patent Application Publication
(10) Pub. No.: US 2018/0316446 A1
(43) Pub. Date: Nov. 1, 2018

(54) METHOD, DEVICE, AND SYSTEM FOR MANAGEMENT AND COMMUNICATION OF A WIRELESS MESH NETWORK

(71) Applicant: Jianghai NIE, Dongguan City (CN)

(72) Inventor: Jianghai NIE, Dongguan City (CN)

(21) Appl. No.: 15/936,160

(22) Filed: Mar. 26, 2018

(30) Foreign Application Priority Data
Mar. 27, 2017 (CN) 201710190108.5

(51) Int. Cl. H04B 17/318; H04W 76/10; H04W 48/16

(52) U.S. Cl. CPC H04B 17/318; H04W 84/12; H04W 48/16; H04W 76/10

(57) ABSTRACT

A method performed at an electronic device for managing a wireless mesh network includes detecting, at the electronic device, signal strengths of wireless signals received from one or more nodes in the wireless mesh network; pairing one of the one or more nodes having the highest signal strength; and managing the wireless mesh network via the paired node.

### CROSS-REFERENCE TO RELATED APPLICATION

This application claims priority to the Chinese Patent Application No. 201710190108.5, filed on Mar. 27, 2017, entitled “METHOD, DEVICE, AND SYSTEM FOR MANAGEMENT AND COMMUNICATION OF A WIRELESS MESH NETWORK,” which is incorporated herein by reference in its entirety.

### FIELD OF THE INVENTION

The present disclosure relates to the field of wireless communications and, more particularly, to a method, device, and system used for a wireless mesh network.

### BACKGROUND OF THE INVENTION

With the continuous development of technology and people's growing need for networks, the Internet of Things (IoT) has inevitably become today's mainstream development trend. As is well known, the basis of the Internet of Things is the interconnection between things. Therefore, simple, stable, and reliable networking capability is one of the important elements for the development of the IoT. For both wired and wireless matters, the importance of wireless IoT connectivity is obvious because of a wide distribution of devices and products connected to the network and advantages of wireless communication technology in networking convenience. In numerous wireless connection technologies, the most widely used and popular technologies are Wi-Fi®, Bluetooth® (BT), ZigBee®, and Z-Wave®. These four technologies have their own advantages, can be applied to different application scenarios, respectively, and have become the most popular communication protocols for wireless IoT connection.

### SUMMARY OF THE INVENTION

However, in networking technologies, especially in short-range communication technologies such as Bluetooth, Wi-Fi, ZigBee, and Z-Wave, etc., in an acentric networking, e.g., a mesh network, mode, the networking is constrained, for example, by the facts of a shorter communication distance, a limited number of nodes for networking (at most eight), and only one control terminal that can be present. By taking Bluetooth as an example, in a Bluetooth mesh network, a communication distance between adjacent nodes is usually within 10 meters, at most eight Bluetooth nodes are included, and at most one of the eight Bluetooth nodes can be paired with the control terminal to achieve control of the entire Bluetooth mesh network.

To this end, Cambridge Silicon Radio plc (CSR) introduced a series of low-cost and low-power Bluetooth chips CSR101x, which may support up to 65,535 Bluetooth devices to constitute a mesh network with a maximal communication distance of about 100 meters and an average communication distance of about 30 to 50 meters between two Bluetooth devices. In addition, each Bluetooth node in the constituted mesh network may be paired with a control terminal via the Bluetooth technology, thereby creating multiple controls over the network.

However, there are still some problems with such a mechanism. First, if a control terminal moves or there are other events which cause a change in signal strengths between the control terminal and various nodes of the Bluetooth mesh network, the control terminal per se cannot change the paired Bluetooth node by itself, thus resulting in a possible loss of the control over the mesh network. Secondly, the control terminal cannot determine types of nodes in the network, and thus cannot achieve effective control over the network.

In order to at least solve or alleviate some of the problems described above, a method and electronic device for managing a wireless mesh network, a method and wireless communication device for communication in a wireless mesh network, a wireless communication system, and a computer readable storage medium according to the embodiments of the present disclosure are proposed.

According to a first aspect of the present disclosure, there is proposed a method performed at an electronic device for managing a wireless mesh network. The method comprises: detecting, at the electronic device, signal strengths of wireless signals received from one or more nodes in the wireless mesh network; pairing with one of the one or more nodes having the highest signal strength; and managing the wireless mesh network via the paired node.

In some embodiments, the wireless mesh network is one of a Bluetooth mesh network, a Wi-Fi mesh network, a ZigBee mesh network, or a Z-Wave mesh network, and the electronic device is paired with the paired node in accordance with a corresponding one of a Bluetooth protocol, a Wi-Fi protocol, a ZigBee protocol, or a Z-Wave protocol. In some embodiments, the method is performed periodically and/or if a current signal strength for the paired node is lower than a predetermined threshold. In some embodiments, the step of managing the wireless mesh network via the paired node comprises the steps of: transmitting a state query message to the wireless mesh network via the paired node; and receiving a state reply message of each node from the wireless mesh network via the paired node. In some embodiments, the method further comprises: determining whether there is a corresponding record in a node state table maintained by the electronic device based on a node identifier in the state reply message; and, if so, updating the existing record, otherwise adding a new record. In some embodiments, the method further comprises: deleting a record for a specific node from the node state table if the specific node does not return a state reply message in response to the state query message within a predetermined time period.

In some embodiments, the transmission of the state query message is performed periodically. In some embodiments, the step of managing the wireless mesh network via the paired node comprises steps of: receiving a state report message for a specific node from the wireless mesh network via the paired node. In some embodiments, the method further comprises: deleting the record for the specific node from a node state table maintained by the electronic device based on a node identifier in the state report message if the state report message indicates that the specific node is powered off; and adding a new record for the specific node into the node state table based on the node identifier in the state report message if the state report message indicates that the specific node is powered on. In some embodiments, the step of managing the wireless mesh network via the paired node comprises steps of: counting a number of nodes of each type in the wireless mesh network based on node type information comprised in a state reply message and/or state report message for each node in the wireless mesh network received via the paired node.

In some embodiments, the method further comprises: providing a user with a user interface on the electronic device for presenting a state of each node in the wireless mesh network and/or for controlling each node in the wireless mesh network.

In some embodiments, at least one node in the wireless mesh network comprises at least one of: a light string, a switch, a dimmer, a receptacle, a water meter, an electric meter, a gas meter, a valve, an alarm, a sensor, a motor, and/or a camera. In some embodiments, if the pairing with the node having the highest signal strength fails, then the electronic device attempts to pair with one of the other nodes having the highest signal strength and the process is repeated until a successful pairing.

In some embodiments, the step of managing the wireless mesh network via the paired node comprises the steps of: for multiple nodes in the wireless mesh network, transmitting messages to the multiple nodes via the paired node, respectively, to make the multiple nodes operate in a cooperative manner.

In some embodiments, making the multiple nodes operate in a cooperative manner comprises at least one of: making the multiple nodes operate in an order specified by the electronic device; and/or making the multiple nodes operate concurrently. In some embodiments, the step of pairing with one of the one or more nodes having the highest signal strength comprises the steps of: initiating a pairing request to the node having the highest signal strength with a default passcode or a user configured passcode; and receiving a response indicating a successful pairing from the node if the passcode is correct. In some embodiments, if one or more nodes of the wireless mesh network except the paired node are paired with another electronic device, then the wireless mesh network is jointly managed by the electronic device and the other electronic device.

According to a second aspect of the present disclosure, there is proposed an electronic device for managing a wireless mesh network. The electronic device comprises: a signal strength detection unit for detecting, at the electronic device, signal strengths of wireless signals received from one or more nodes in the wireless mesh network; a node pairing unit for performing pairing with one of the one or more nodes having the highest signal strength; and a network management unit for managing the wireless mesh network via the paired node.

According to a third aspect of the present disclosure, there is proposed an electronic device. The electronic device comprises: a processor; a wireless communication module; a memory storing instructions which, when executed by the processor, cause the processor to: determine signal strengths of wireless signals received through the wireless communication module from one or more nodes in the wireless mesh network; instruct the wireless communication module to pair with one of the one or more nodes having the highest signal strength; and manage the wireless mesh network via the paired node through the wireless communication module.

According to a fourth aspect of the present disclosure, there is proposed a communication method performed at a wireless communication device in a wireless mesh network. The method comprises: detecting signal strengths of wireless signals received from one or more nodes in the wireless mesh network; establishing a wireless connection to a first node in the one or more nodes in accordance with a predetermined criterion; and communicating with other nodes in the wireless mesh network via the wireless connection.

In some embodiments, the wireless mesh network is one of a Bluetooth mesh network, a Wi-Fi mesh network, a ZigBee mesh network, or a Z-Wave mesh network, and the wireless communication device is a corresponding one of a Bluetooth communication device, a Wi-Fi communication device, a ZigBee communication device, or a Z-Wave communication device. In some embodiments, the predetermined criterion is at least one of: the first node detected in a chronological order; and/or the detected node having the highest signal strength. In some embodiments, the method further comprises: storing information for other nodes of the one or more nodes than the first node as alternative nodes. In some embodiments, the step of communicating with other nodes in the wireless mesh network via the wireless connection comprises the steps of: receiving a state query message from the wireless mesh network via the wireless connection; and transmitting a state reply message to the wireless mesh network via the wireless connection based on a configuration and/or state of the wireless communication device.

In some embodiments, the step of communicating with other nodes in the wireless mesh network via the wireless connection comprises the steps of: transmitting a state report message to the wireless mesh network via the wireless connection.

In some embodiments, the state report message and/or the state reply message comprise at least a node identifier and/or node type of the wireless communication device. In some embodiments, the wireless communication device comprises at least one of: a light string, a switch, a dimmer, a receptacle, a water meter, an electric meter, a gas meter, a valve, an alarm, a sensor, a motor, and/or a camera.

In some embodiments, if the establishment of the wireless connection with the first node fails, then the wireless communication device attempts to establish a wireless connection with a second node of the other nodes which meets the predetermined criterion and the process is repeated until a wireless connection is established successfully.

In some embodiments, the step of establishing a wireless connection with a first node in the one or more nodes in accordance with a predetermined criterion comprises steps of: initiating a connection request to the first node with a default passcode or a user configured passcode; and receiving a response indicating a success connection from the first node if the passcode is correct.

In some embodiments, the method further comprises: establishing a paired connection with an electronic device outside of the wireless mesh network. In some embodiments, the method further comprises: receiving a state query message from the electronic device via the paired connection; and transmitting a state reply message to the electronic device via the paired connection based on a configuration and/or state of the wireless communication device.

In some embodiments, the method further comprises: forwarding the state query message to other nodes in the wireless mesh network via the wireless connection; receiving state reply messages from the other nodes in the wireless mesh network via the wireless connection; and forwarding the state reply messages for the other nodes to the electronic device via the paired connection. In some embodiments, the method further comprises: transmitting a state report message to the electronic device via the paired connection. In some embodiments, the method further comprises: receiving state report messages from other nodes in the wireless mesh network via the wireless connection; and forwarding the state report messages for other nodes to the electronic device via the paired connection.

According to a fifth aspect of the present disclosure, there is proposed a wireless communication device in a wireless mesh network. The wireless communication device comprises: a signal strength detection unit for detecting signal strengths of wireless signals received from one or more nodes in the wireless mesh network; a wireless connection establishment unit for establishing a wireless connection with a first node in the one or more nodes in accordance with a predetermined criterion; and a wireless communication unit for communication with other nodes in the wireless mesh network via the wireless connection.

According to a sixth aspect of the present disclosure, there is proposed a wireless communication device. The wireless communication device comprises: a processor; a wireless communication module; a memory storing instructions which, when executed by the processor, cause the processor to: detect signal strengths of wireless signals received through the wireless communication module from one or more nodes in the wireless mesh network; establish a wireless connection through the wireless communication module with a first node in the one or more nodes in accordance with a predetermined criterion; and communicate with other nodes in the wireless mesh network through the wireless communication module via the wireless connection.

According to a seventh aspect of the present disclosure, there is proposed a wireless communication system comprising one or more wireless communication devices according to the fifth aspect and/or the sixth aspect of the present disclosure.

According to an eighth aspect of the present disclosure, there is proposed a computer readable storage medium storing instructions which, when executed by a processor, cause the processor to perform the method according to the first aspect of the present disclosure.

According to a ninth aspect of the present disclosure, there is proposed a computer readable storage medium storing instructions which, when executed by a processor, cause the processor to perform the method according to the fourth aspect of the present disclosure.

With the various methods, electronic devices, wireless communication devices, systems, and computer readable storage media according to the embodiments of the present disclosure, flexible control of the Internet of Things can be achieved and the network can be established and managed in a low-cost and simple operation mode.

### BRIEF DESCRIPTION OF THE DRAWINGS

The above and other objects, features and advantages of the present disclosure will become more apparent from the following description of preferred embodiments of the present disclosure with reference to the accompanying drawings in which:

FIG. 1 is a schematic diagram illustrating an application scenario of a wireless mesh network according to an embodiment of the present disclosure.

FIG. 2 is a schematic diagram illustrating a hardware arrangement of an example electronic device according to an embodiment of the present disclosure.

FIG. 3 is a schematic diagram illustrating a hardware arrangement of an example wireless communication device according to an embodiment of the present disclosure.

FIG. 4 is a message flow illustrating an example method for managing a wireless mesh network according to an embodiment of the present disclosure.

FIG. 5 is a message flow illustrating an example method for communication in a wireless mesh network according to an embodiment of the present disclosure.

FIG. 6 is a flowchart illustrating an example method for managing a wireless mesh network according to an embodiment of the present disclosure.

FIG. 7 is a schematic diagram illustrating an example electronic device for managing a wireless mesh network according to an embodiment of the present disclosure.

FIG. 8 is a flowchart illustrating an example method for communication in a wireless mesh network according to an embodiment of the present disclosure.

FIG. 9 is a schematic diagram illustrating an example wireless communication device for communication in a wireless mesh network according to an embodiment of the present disclosure.

### DETAILED DESCRIPTION OF THE INVENTION

Embodiments of the present disclosure will be described in detail below with reference to the accompanying drawings, in which details and functions which are not necessary for the present disclosure are omitted in the description in order to prevent confusion in the understanding of the present disclosure. In the present specification, the following description of various embodiments for describing the principles of the present disclosure is illustrative only and should not be construed as limiting the scope of the disclosure in any way. The following description of the drawings, with reference to the accompanying drawings, is provided to assist in a comprehensive understanding of the example embodiments of the disclosure as defined by the claims and their equivalents. The following description includes many specific details to assist in the understanding, but such details are to be regarded as merely exemplary. Accordingly, those of ordinary skill in the art will recognize that numerous changes and modifications can be made to the embodiments described herein without departing from the scope and spirit of the present disclosure. In addition, descriptions of well-known functions and structures are omitted for clarity and conciseness. In addition, the same reference numerals are used for the same or similar functions and operations throughout the accompanying drawings.

Hereinafter, the present disclosure is described in detail, by taking a situation in which the present disclosure is applied to an electronic device as an example. However, the present disclosure is not limited thereto, and the present disclosure may also be applied to any suitable device. With respect to the electronic device, the present disclosure is not limited to a specific operating system of the electronic device, and may include, but is not limited to, iOS, Windows Phone, Symbian, Android, Windows, Linux, etc. Different electronic devices may use the same operating system, or may use different operating systems.

In addition, some embodiments of the present disclosure will be described in detail below by taking the Bluetooth communication technology as an example. However, it will be understood by those skilled in the art that the embodiments of the present disclosure may equally be applicable to other wireless communication technologies including, but not limited to: BT, Wi-Fi, ZigBee, Z-Wave, Infrared Data Association (IrDA), RFID, NFC, etc.

In addition, although some embodiments of the present disclosure are described below by taking Internet of Things (for example, light strings, switches, dimmers etc.) “objects in the home” as an example, those skilled in the art will appreciate that the embodiments of the present disclosure may equally be applicable to other fields, places and situations. For example, the embodiments of the present disclosure may be used for the management and monitoring of pipelines and valves, instruments, etc., in a factory, or for building security, fireproofing and guarding against theft, remote checking of water meters, electric meters and gas meters, etc.

In the present disclosure, the terms “comprising” and “including” and their derivatives are intended to be inclusive instead of being limiting, and the term “or” may be inclusive, which means “and/or.” In the following, some of the terms to be used in the present disclosure will be explained first.

Bluetooth (BT): A wireless technology standard which can enable short-range data exchange between fixed devices, mobile devices, and personal area networks in a building (using, for example, UHF radio waves in the ISM band of 2.4 to 2.485 GHz). Bluetooth technology was originally released by Ericsson in 1994 as an alternative to RS232 data lines. Today, Bluetooth is managed by the Bluetooth Special Interest Group (SIG). With more than 25,000 member companies worldwide, the Bluetooth SIG is distributed in a diverse range of industries such as telecommunications, computers, networks, and consumer electronics. IEEE listed the Bluetooth technology as IEEE 802.15.1, but this standard is no longer maintained today. The Bluetooth SIG is responsible for monitoring the development of the Bluetooth specification, managing certification programs, and maintaining trademark rights. A manufacturer's device must meet the Bluetooth SIG standard to enter the market in the name of “Bluetooth device”. The Bluetooth technology has a set of patented networks, which can be distributed to devices which meet the standard.

Wireless Mesh Networks (WMNs): A wireless mesh network is a network of wireless nodes organized in a mesh topology. It can also be referred to as an ad hoc network. In addition to being responsible for the transmission/reception of its own communication traffic, each mesh network node also typically serves as a relay/intermediate node for other surrounding nodes. In other words, each network node also forwards data transmitted/received by other network nodes. Since two nodes within a communication range can communicate with each other directly, there may be redundant links in the wireless mesh network, and thus the network can be self-healing.

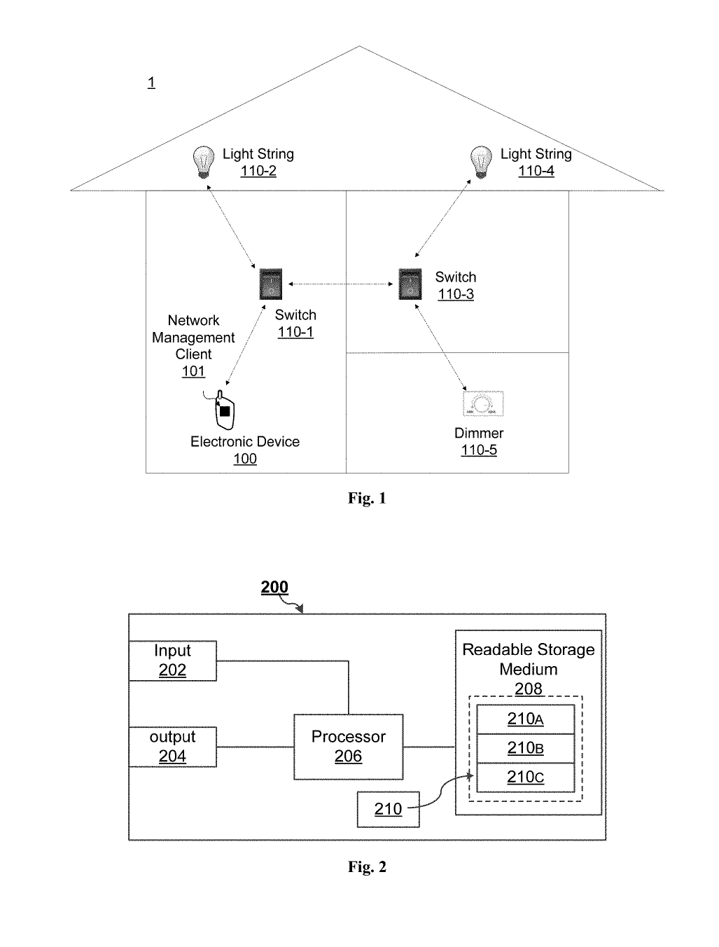

In the following, a schematic diagram of an application scenario of a wireless mesh network according to an embodiment of the present disclosure will be generally described with reference to FIG. 1. FIG. 1 illustrates a schematic diagram of an application scenario of a wireless mesh network 1, according to an embodiment of the present disclosure. In the embodiment shown in FIG. 1, each node in the wireless mesh network 1 may be arranged at any location at home. For example, the wireless mesh network 1 may include light strings 110-2 and 110-4 arranged on a roof, switches 110-1 and 110-3 disposed at different locations in the house (e.g., a living room and a bedroom), and a dimmer 110-5 arranged in the study room. Hereinafter, these will be collectively referred to as a wireless communication device (or node) 110, unless otherwise specified.

However, those skilled in the art will appreciate that the embodiments of the present disclosure are not limited thereto. In fact, the wireless mesh network 1 may comprise any number/type of various wireless communication nodes (devices), and locations of these wireless communication nodes may also be different and/or vary. For example, the wireless mesh network 1 may also comprise a sweeping robot having a wireless communication capability, which can move in the house without a fixed position.

In addition, the wireless mesh network 1 may also include an electronic device 100 that may be used to manage and/or control other nodes in the wireless mesh network 1 as a management device (or a management node) of the wireless mesh network 1. For simplicity and clarity, only one electronic device 100 is shown in the figure, but the present disclosure is not limited thereto, and instead may include two or more electronic devices 100, etc. In some embodiments, the electronic device 100 may include, but is not limited to, at least one of the following: a smartphone, a tablet computer, a notebook computer, or any other electronic device having wireless (or wired) communication capabilities.

The electronic device 100 may belong to a user or may be operated by a user. The electronic device 100 may communicate, through a particular node in the wireless mesh network 1 (e.g., the switching node 110-1 shown in FIG. 1), with other nodes in the network. In the embodiment shown in FIG. 1, in order to manage the wireless mesh network 1 on the electronic device 100, a network management client 101 (hereinafter referred to as a client 101) according to an embodiment of the present disclosure may be installed in the electronic device 100. The client 101 may be installed in the electronic device 100 by the user in a form of software, or may be installed in the electronic device 100 by a manufacturer in a form of hardware or firmware. In some embodiments, the client 101 may be, for example, application software dedicated to the embodiments of the present disclosure which is downloaded from the network after a user has purchased the electronic device 100. In some other embodiments, the client 101 may be, for example, an application preinstalled in the electronic device 100 by a manufacturer in a form of firmware or hardware. In still other embodiments, the client 101 may be a hardware module or the electronic device 100 may be manufactured by a manufacturer. The terms “electronic device” and “client” may be used interchangeably, unless otherwise specified hereinafter.

In addition, since the non-mesh networking technology (for example, using a Bluetooth pairing mode, a Wi-Fi direct connection mode, or other ad-hoc modes, etc.) may be used between the electronic device 100 and the switch 110-1, the electronic device 100 may also be considered not to be a part of the wireless mesh network 1 but to be a device outside the wireless mesh network 1.

Thus, by, for example, pairing the electronic device 100 with the switch 110-1, the electronic device 100 may communicate with other nodes in the wireless mesh network 1 via the switch 110-1, and thereby control the other nodes and/or monitor operating states thereof. In addition, since a plurality of electronic devices 100 may be paired with different nodes respectively and manage the wireless mesh network 1 as described above, the plurality of electronic devices 100 may manage the network 1 in a joint manner. For example, instructions issued by each of the electronic devices 100 to various nodes in the network may be sequentially executed in a chronological order, or executed in accordance with the authority of each of the electronic devices 100 (for example, instructions from an electronic device 100 with a high authority precede instructions from an electronic device 100 with a low authority).

In some embodiments, the electronic device 100 may also perform cooperative control of a plurality of nodes in the wireless mesh network 1. For example, the electronic device 100 may instruct the light string 110-2 and the light string 110-4 to operate in series to form a longer light string and thereby achieve more complex visual effects. In addition, the electronic device 100 may also direct the respective nodes in other orders. For example, the electronic device 100 may allow the light strings 110-2 and 110-4 to operate concurrently, flicker in the same mode, etc. In addition, the electronic device 100 may allow the switch 110-1 and the switch 110-3 to operate in cooperation so that devices (e.g., projectors, stereos, etc.) associated with the switches 110-1 and 110-3 operate in cooperation. Thus, the wireless mesh network 1 may be controlled in a variety of ways by the same electronic device 100. More generally, the electronic device 100 may control a plurality of nodes such that the plurality of nodes may operate in an order specified by the electronic device 100 and/or the plurality of nodes operate concurrently. For example, each node may have its own clock, and clocks of various nodes may be substantially synchronized, in which case the electronic device 100 may instruct each node to perform a particular action at a particular time in an instruction transmitted to said each node, so as to achieve cooperation among the various nodes. In a case that all or a part of the nodes do not have a clock, different instructions may be transmitted by the electronic device 100 to different nodes at different times respectively, in a desired chronological order, which can also achieve the effect of cooperative operation. In addition, the instructions may also have a delay effect; for example, a certain node may be instructed to execute an action after a specified time, so as to achieve the effect of cooperative operation with other nodes. Constructions of the electronic device 100 and the wireless communication device 110, and a workflow thereof will be described in detail hereinafter. In addition, the messages used therebetween will also be described in detail below.

Next, a hardware arrangement of the electronic device 100 will be described in detail with reference to FIG. 2. FIG. 2 is a diagram illustrating a hardware arrangement of an example electronic device 200 (which may be an example of the electronic device 100 shown in FIG. 1), according to an embodiment of the present disclosure. The hardware arrangement 200 may comprise a processor 206 (e.g., a Digital Signal Processor (DSP), a Central Processing Unit (CPU), etc.). The processor 206 may be a single processing unit or a plurality of processing units for performing different actions of the flow described herein. The arrangement 200 may also comprise an input unit 202 for receiving signals from other entities, and an output unit 204 for providing signals to other entities. The input unit 202 and the output unit 204 may be arranged as a single entity or separate entities. In some embodiments, the input unit 202 and the output unit 204 may be a wireless communication module (e.g., a Bluetooth communication module, a Wi-Fi communication module, a ZigBee communication module, or a Z-Wave communication module).

In addition, the arrangement 200 may comprise at least one readable storage medium 208 in a form of non-volatile or volatile memory, such as an Electrically Erasable Programmable Read-Only Memory (EEPROM), a flash memory, and/or a hard disk driver. The readable storage medium 208 comprises a computer program 210 which includes codes/computer readable instructions that, when executed by the processor 206 in the arrangement 200, cause the hardware arrangement 200 and/or the device 100 including the hardware arrangement 200 (or the electronic device 700 shown in FIG. 7) to perform, for example, flows described below in connection with FIGS. 4-6 and any variations thereof.

The computer program 210 may be configured with computer program codes having, for example, architecture of computer program modules 210A-210C. Therefore, in an example embodiment when the hardware arrangement 200 is used in the electronic device shown in FIG. 1, the codes in the computer program of the arrangement 200 may comprise a module 210A for detecting, at the electronic device 100, signal strengths of wireless signals transmitted from one or more nodes 110 in the wireless mesh network. The codes in the computer program also comprise a module 210B for pairing with the node 110-1 of the one or more nodes 110 having the highest signal strength. The codes in the computer program also comprise a module 210C for managing the wireless mesh network 1 via the paired node 110-1.

The computer program modules may substantially perform the various actions in the flow shown in FIGS. 4-6 to simulate the electronic device 100 or 700. In other words, when different computer program modules are executed in the processor 206, they may correspond to different units in the device 700 shown in FIG. 7.

Although the following code means in the embodiments disclosed in conjunction with FIGS. 4-6 are implemented as computer program modules that, when executed in the processor 206, cause the hardware arrangement 200 to perform the actions described below in connection with FIGS. 4-6, in alternative embodiments, at least one of the code means may be implemented at least in part as a hardware circuit.

The processor may be a single Central Processing Unit (CPU), but may also comprise two or more processing units. For example, the processor may comprise a general purpose microprocessor, an instruction set processor, and/or a related chipset and/or a dedicated microprocessor (for example, an Application Specific Integrated Circuit (ASIC)). The processor may also comprise an on-board memory for caching purposes. The computer program may be carried by a computer program product connected to the processor. The computer program product may comprise a computer-readable medium having stored thereon a computer program. For example, the computer program product may be a flash memory, a Random Access Memory (RAM), a Read Only Memory (ROM), and an EEPROM, and the computer program module may, in an alternative embodiment, be distributed to different computer program products in a form of memory within the user equipment (UE).

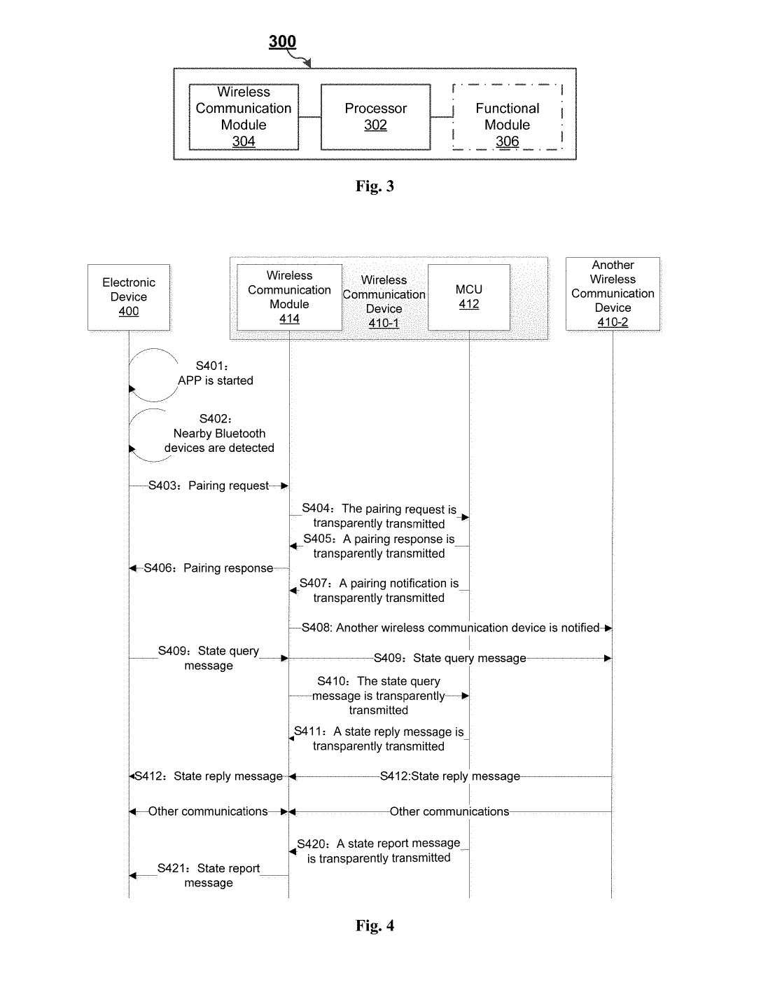

Next, a hardware arrangement of each wireless communication device (node) 110 will be described in detail with reference to FIG. 3. FIG. 3 is a diagram illustrating a hardware arrangement of an example wireless communication device 300 (which may be an example of the wireless communication device 110 shown in FIG. 1) according to an embodiment of the present disclosure. The hardware arrangement 300 may comprise a processor 302 (e.g., a Microcontroller Unit (MCU)). The processor 302 may be a single processing unit or a plurality of processing units for performing different actions of the flow described herein. In some embodiments, the processor 302 may be a microcontroller such as STM8S105K6, STM8S003, etc., as pushed by STMicroelectronics. The arrangement 300 may further comprise a wireless communication module 304 (for example, a Bluetooth communication module, a Wi-Fi communication module, a ZigBee communication module, or a Z-Wave communication module) for communication with other entities. In some embodiments, the wireless communication module 304 may be a CSR101x series of low power Bluetooth chips introduced by the CSR company.

In addition, the arrangement 300 may comprise at least one readable storage medium (not shown) in a form of non-volatile or volatile memory, such as an EEPROM, a flash memory, and/or a hard disk driver. The readable storage medium comprises a computer program which includes codes/computer readable instructions that, when executed by the processor 302 in the arrangement 300, enable the hardware arrangement 300 and/or the wireless communication device 110, including the hardware arrangement 300, or the wireless communication device 900 shown in FIG. 9 to perform, for example, the flow described below in connection with FIGS. 4 to 5 and 8, and any variations thereof.

The computer program may be configured with computer program codes, having for example computer program module architecture. Therefore, in an example embodiment when the hardware arrangement 300 is used in the wireless communication device 110 illustrated in FIG. 1, the codes in the computer program of the arrangement 300 comprise a first module for detecting signal strengths of wireless signals received from one or more nodes 110-2, 110-3, 110-4, and 110-5 in the wireless mesh network 1. The codes in the computer program further comprise a second module for establishing, in accordance with a predetermined criterion, a wireless connection to a first node (e.g., a switch 110-3) in the one or more nodes 110-2, 110-3, 110-4, and 110-5. The codes in the computer program further comprise a third module for communication with other nodes in the wireless mesh network 1 via the wireless connection.

The computer program module may substantially perform various actions in the flows illustrated in FIGS. 4-5 and 8 to simulate the wireless communication device 110 or 900. In other words, when different computer program modules are executed in the processor 302, they may correspond to different units in the device 900.

While the code means in the embodiments disclosed above in connection with FIGS. 4-5 and 8 are implemented as computer program modules that, when executed in the processor 302, cause the hardware arrangement 300 to perform the actions described above in connection with FIGS. 4-5 and 8, in alternative embodiments, at least one of the code means may be implemented at least in part as a hardware circuit.

The processor may be a single Central Processing Unit (CPU), but may also comprise two or more processing units. For example, the processor may comprise a general purpose microprocessor, an instruction set processor, and/or a related chipset and/or a dedicated microprocessor (e.g., an Application Specific Integrated Circuit (ASIC)). The processor may also comprise an on-board memory for caching purposes. The computer program may be carried by a computer program product connected to the processor. The computer program product may comprise a computer-readable medium having stored thereon a computer program. For example, the computer program product may be a flash memory, a Random Access Memory (RAM), a Read Only Memory (ROM), and an EEPROM, and the computer program module may, in an alternative embodiment, be distributed to different computer program products in a form of memory within the UE.

In addition, the arrangement 300 may further comprise an optional functional module 306 to implement different functions. For example, the functional module 306 may comprise, but is not limited to, at least one of: a light string module, a switch module, a dimmer module, a sensor module, a receptacle module, a water meter module, an electric meter module, a gas meter module, a valve module, an alarm module, a motor module, and/or a camera module, etc. The processor module 302 may interact with the functional module 306 through various interfaces (e.g., an SPI bus, an I²C bus, or any other appropriate interface, etc.) and may control the functional module 306 to operate according to instructions from the electronic device 100 and 200, or other electronic device.

Next, an example method for managing a wireless mesh network according to an embodiment of the present disclosure will be described in detail with reference to FIGS. 1-3 and with reference to FIG. 4. FIG. 4 is a message flow illustrating an example method for managing a wireless mesh network according to an embodiment of the present disclosure. Specifically, FIG. 4 illustrates an example message flow for managing a wireless mesh network among an electronic (management) device 400 (e.g., as an example of the electronic device 100 in FIG. 1 or the electronic device 200 in FIG. 2), a wireless communication device (node) 410-1, and another wireless communication device (node) 410-2 (e.g., as an example of the wireless communication device 110 in FIG. 1 or the wireless communication device 300 in FIG. 3). In addition, a message flow between the wireless communication module 414 and the MCU 412 included in the wireless communication device 410-1 is further illustrated.

As shown in FIG. 4, the flow starts at step S401. In step S401, a user may start a network management application (e.g., the network management client 101 shown in FIG. 1) on the electronic device 400 by, for example, clicking on an application icon on the electronic device 400 or powering on the electronic device 400. When the application (hereinafter sometimes simply referred to as APP) is initialized, it can detect whether the wireless communication module on the electronic device 400 is started, for example, whether its Bluetooth module is started. If it detects that the Bluetooth module is not started, the user may be prompted to manually start the Bluetooth module or the Bluetooth module is automatically started by the application itself.

After it is determined that the wireless communication module is started, the electronic device 400 may detect broadcast signals of its peripheral Bluetooth devices in step S402 to determine signal strengths from various nodes. When, for example, the electronic device 400 determines that the wireless signal strength of the wireless communication device 410-1 is strongest, it may select the wireless communication device 410-1 as a paired node (or a bridge node) to pair therewith and communicate with other nodes in the wireless mesh network through the paired node.

When the wireless communication device 410-1 is selected as the paired node, the electronic device 400 may transmit a pairing request to the wireless communication module 414 of the wireless communication device 410-1, for example, via a Bluetooth protocol in step S403. The pairing request may optionally comprise a password (or PIN) for pairing. After the wireless communication module 414 receives the pairing request, it may process (for example, strip) a Bluetooth header of the pairing request and transparently pass a payload to the MCU 412 in step S404. After receiving the pairing request, the MCU 412 may optionally determine whether the password is correct according to, for example, a preset configuration and, in turn, returns a pairing response to the wireless communication module 414 in step S405. If no password is set, the pairing response may be returned directly to the wireless communication module 414 in step S405. The wireless communication module 414 may, in turn, correspondingly add the Bluetooth header to the pairing response returned by the MCU 412 and forward it to the electronic device 400 in step S406.

In addition, in some other embodiments, the wireless communication module 414 may process the pairing request itself without forwarding the pairing request to the MCU 412. In other words, the pairing process may be performed in any hardware/software module in the wireless communication device 410-1. In this case, steps S404 and S405 may be omitted, the pairing response may be returned directly to the electronic device 400, and the wireless communication module 414 may optionally report to the MCU 412 as to whether the pairing is successful.

In addition, in some embodiments, after the electronic device 400 is paired with the wireless communication device 410-1 successfully, the MCU 412 and/or the wireless communication module 414 may, in steps S407 and S408, optionally transmit a notification message that it paired with the electronic device 400 successfully to other wireless communication devices (e.g., another wireless communication device 410-2) in the wireless mesh network. In this way, the other wireless communication device 410-2 may be aware of the presence of the paired node 410-1 and the electronic device 400 which is paired with the paired node 410-1 in the wireless mesh network, and thus may report its own operating state to the electronic device 400.

In addition, as the electronic device 400 may be a mobile device such as a mobile phone, a tablet, a notebook computer, a wearable device, etc., or for other reasons, a signal strength of a connection between the electronic device 400 and a paired node in the wireless mesh network may vary with time. For example, when the electronic device 400 moves away from the wireless communication device 410-1 and approaches the other wireless communication device 410-2, it may desire to pair the electronic device 400 with the other wireless communication device 410-2 to achieve a more stable and high-speed connection. In this case, the electronic device 400 may be allowed to re-execute the steps S402-S406 periodically (e.g., every 5 seconds) to ensure a stable and high-speed connection between the electronic device 400 and the wireless mesh network. In addition, steps S402-S406 may be repeated when the electronic device 400 detects that the signal strength between the electronic device 400 itself and the current paired node (e.g., the wireless communication device 410-1) is lower than a predetermined threshold value to avoid loss of the connection with the wireless mesh network.

In some embodiments, after the electronic device 400 is successfully paired with the wireless communication device 410-1, the electronic device 400 may transmit a state query message to the wireless mesh network to request each node in the network to return information indicating its own operating state. For example, in step S409, the electronic device 400 may transmit a state query message to the wireless communication device 410-1 to request the wireless communication device 410-1 to return a state reply message indicating its operating state. At the same time, the state query message may be broadcasted to other nodes in the wireless mesh network, and each node receiving the state query message may return to the electronic device 400 a state reply message indicating its own operating state, either directly or indirectly. For example, the electronic device 400 may transmit a state query message to the other wireless communication device 410-2 via the wireless communication device 410-1 and may further transmit a state query message to a further wireless communication device via the wireless communication device 410-2.

In step S410, the wireless communication module 414 of the wireless communication device 410-1 receiving the state query message may process the state query message to remove a Bluetooth header and forward the remaining portions to the MCU 412. After receiving the state query message, the MCU 412 may return a corresponding state reply message to the wireless communication module 414 according to its own configuration parameters and/or operating state in step S411 and the state reply message is processed and then is returned by the wireless communication module 414 to the electronic device 400.

Similarly, the other wireless communication device 410-2, which receives the state query message forwarded by the wireless communication device 410-1, may also forward the state reply message indicating the operating state of the other wireless communication device 410-2 to the electronic device 400 via the wireless communication module 414 of the wireless communication device 410-1 in step S412.

Thus, with the above message flow, the electronic device 400 can establish a pairing relationship with the paired node 410-1 in the wireless mesh network and acquire the operating state of each node in the wireless mesh network via the paired node 410-1 and can transmit instructions to various nodes respectively via the paired node 410-1.

In addition, the wireless communication device 410-1 may also actively report its own operating state (e.g., power on, power off, gas leakage detection, window open, or any other conditions requiring reporting of operating states, etc.) to the electronic device 400 after the pairing process. Specifically, as shown in steps S420 and S421, when a state of a functional module (not shown) of the wireless communication device 410-1 and/or the MCU 412 is required to be reported, the MCU 412 may transmit a state report message to the electronic device 400 via the wireless communication module 414, or the wireless communication module 414 may transmit a state report message directly to the electronic device 400.

For example, when the wireless communication device 410-1 is powered off (e.g., a user directly turns off a switch of the wireless communication device 410-1 or unplugs its power supply line), the wireless communication device 410-1 may detect a power-off condition while transmitting a state report message to the electronic device 400 or other nodes in the wireless mesh network to report the power-off condition of itself through its remaining electric quantity (e.g., electric quantity for maintaining an operating time of 20 ms) in a power storage circuit (e.g., a capacitor, etc.) in its own circuit. In this way, after receiving the state report message, the electronic device 400 may update the maintained list of nodes (devices) in the wireless mesh network in time so that the user can accurately view this state in time.

Likewise, the other wireless communication device 410-2 may also actively transmit a state report message to the electronic device 400. In this way, the electronic device 400 can update the maintained list of nodes (devices) in the wireless mesh network in time so that the user can accurately view this state in time.

When the electronic device 400 receives a state reply message and/or a state report message, it can accordingly maintain each managed list of nodes (which may be referred to as a list of devices or a node state table) in the wireless mesh network. As will be described in more detail below, each message may comprise a node Identifier (ID) for identifying a source node of a message and/or a type for identifying a type of the node. In this case, if the state report message and/or the state reply message indicates that the corresponding node is powered off, the electronic device 400 may delete a record for the corresponding node from the node state table according to the node identifier in the message. In addition, if the state report message and/or the state reply message indicates that the corresponding node is powered on, then a new record for the corresponding node may be added to the node state table according to the node identifier in the message.

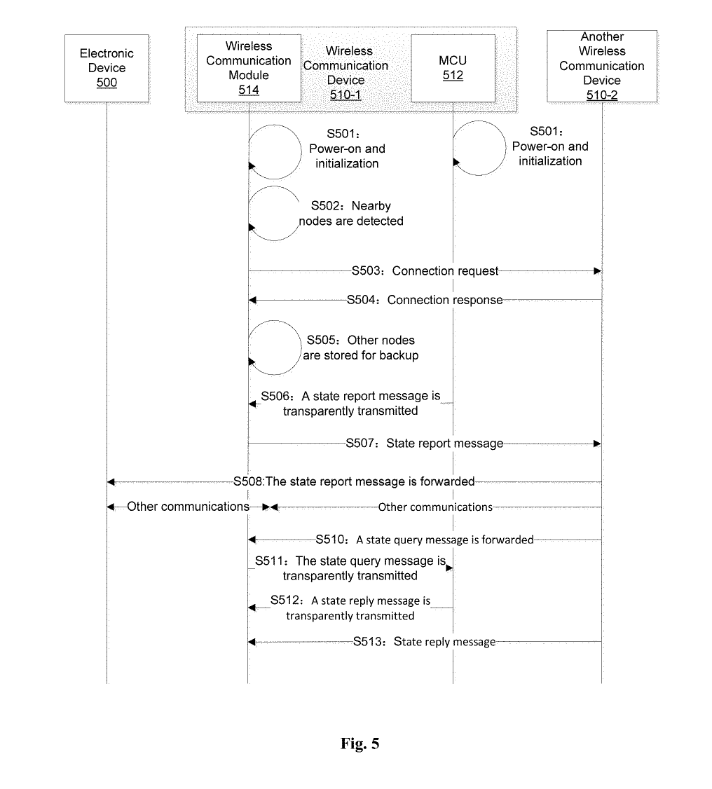

Next, an example method for communication in a wireless mesh network according to an embodiment of the present disclosure will be described in detail in conjunction with FIGS. 1-3 and with reference to FIG. 5. FIG. 5 is a message flow illustrating an example method for communication in a wireless mesh network according to an embodiment of the present disclosure. Specifically, FIG. 5 illustrates an example message flow for communication in the wireless mesh network among an electronic device 500 (e.g., an example of the electronic device 100 shown in FIG. 1 and the electronic device 200 shown in FIG. 2), a wireless communication device 510-1 and another wireless communication device 510-2 (e.g., an example of the wireless communication device 110 shown in FIG. 1 or the wireless communication device 300 shown in FIG. 3). In addition, a message flow between a wireless communication module 514 and an MCU 512 included in the wireless communication device 510-1 is further illustrated.

As shown in FIG. 5, the flow starts at step S501. In step S501, both of the MCU 512 and the wireless communication module 514 in the wireless communication device 510-1 are powered on and initialized. In some embodiments, after both of the MCU 512 and the wireless communication module 514 are initialized, messages indicating that the initializations are successful may be transmitted to each other so that one party can confirm that the other party can operate properly. In some other embodiments, an initialization success message may also be transmitted unilaterally so that at least one of the MCU 512 and the wireless communication module 514 may be aware of whether the entire wireless communication device 510-1 can operate properly.

Then, in step S502, the wireless communication module 514 may listen for signals of peripheral nodes and acquire required information therefrom. The information may comprise a network ID and/or a node ID of a peripheral node, etc. In some embodiments, the wireless communication device 510-1 may select a node of which it joins a network according to a preset configuration or rule. For example, the wireless communication device 510-1 may determine whether it is a product of the same type and/or from a same manufacturing company according to the network ID of the peripheral node and whether it should join the mesh network.

In addition, the wireless communication module 514 may also determine signal strengths of the peripheral nodes. According to the determined signal strengths of various nodes, the wireless communication module 514 may select at least one of the nodes to be connected according to a preset criterion. In some embodiments, the preset criterion may be selection of the first node detected in a chronological order, or selection of a detected node with the highest signal strength, etc. In addition, the node to be connected may also be selected in connection with the above-described judgment of the network to be joined.

After determining another wireless communication device (node) 510-2 that is expected to be connected, the wireless communication device 510-1 may transmit a connection request to the other wireless communication device 510-2 in step S503, and receives a connection response from the other wireless communication device 510-2 in step S504. In some embodiments, the connection request may comprise a password (or PIN) for authentication. The other wireless communication device 510-2 may determine whether to allow the wireless communication device 510-1 to connect according to the password and/or other criteria (e.g., an ID of a device that initiated a connection request).

In addition, in some embodiments, the wireless communication device 510-1 may, after determining the node to be connected, store information of the remaining nodes locally for backup in step S505. For example, when the current connection node is powered off or the signal strength is too low, a node that satisfies a predetermined criterion may be selected from standby nodes for reconnection to prevent disconnection from the wireless mesh network.

Further, in some embodiments, the wireless communication device 510-1 may not be connected to any particular node, but operate in a broadcast mode. In this way, it can transmit its messages to all the peripheral nodes and receive messages from all the nodes, which can also implement the solution according to the embodiments of the present disclosure.

Next, after the connection with the other wireless communication device 510-2 (or more generally, the wireless mesh network) is successful, the MCU 512 may, in steps S506 and S507, transmit a state report message to the other wireless communication device 510-2 according to its own configuration and/or operating state via the wireless communication module 514. A destination of the state report message will be a management device for the wireless mesh network, such as the electronic device 500 shown in FIG. 5. A manner of addressing the electronic device 500 may be to broadcast the state report message, or the electronic device 500 may be addressed according to an address of the management device and/or its associated wireless communication device stored in each wireless communication device in the network. However, the present disclosure is not limited thereto.

After receiving the state report message forwarded by the other wireless communication device 510-2 in step S508, the electronic device 500 may maintain a node state table for the wireless mesh network according to the message. For example, as described above, for a wireless communication device newly joining the wireless mesh network, a corresponding record thereof is newly added in the node state table; or for a wireless communication device of which a state changes, a corresponding record thereof is modified in the node state table; or for a wireless communication device exiting the wireless mesh network, a corresponding record thereof is deleted from the node state table.

In addition, in some embodiments, the electronic device 500 or other management devices may also actively transmit a state query message to the wireless communication device 510-1, similarly to steps S409-S412 shown in FIG. 4. The state query message may be transmitted to the wireless communication device 510-1 through the other wireless communication device 510-2 or other nodes not shown in FIG. 5. For example, in the embodiment shown in FIG. 5, the state query message may be transmitted to the wireless communication module 514 of the wireless communication device 510-1 through the other wireless communication device 510-2 in step S510. Then, in step S511, the state query message is transparently transmitted to the MCU 512 by the wireless communication module 514. In steps S512 and S513, the MCU 512 returns a state reply message to the other wireless communication module 510-2 via the wireless communication module 514 according to its own configuration and/or state. The other wireless communication device 510-2 may forward the state reply message to the electronic device 500 or other management devices accordingly.

In addition, although only a few messages between the electronic device 400 and the wireless communication device 410 are described above, which are a state query message/state reply message, and a state report message, the present disclosure is not limited thereto. In fact, a variety of message instructions may exist between the electronic device 400 and the wireless communication device 410. For example, Table 1 below shows some possible message types according to the embodiments of the present disclosure. However those skilled in the art will understand that the present disclosure is not limited thereto and may include message types for implementing various functions between the electronic device 400 and the wireless communication device 410.

TABLE 1
Exemplary Message Types

| | Byte 1 | | | | | | | |
|---|---|---|---|---|---|---|---|---|
| | High | Low 4 | | | | | | |
| Description | 4 bits | bits | Byte 2 | Byte 3 | Byte 4 | Byte 5 | Byte 6 | Examples |
| Online state | 1-F | 0x1 | 0x0 | 0x0 | 0x0 | 0x0 | 0x0 | 0x11 0x00 0x00 0x00 0x00 0x00 |
| query | | | | | | | | |
| Overall | 1-F | 0x2 | 0x0: | 0x0 | 0x0 | 0x0 | 0x0 | 0x22 0x00 0x00 0x00 0x00 0x00 |
| switch | | | turn | | | | | all devices are turned off |
| instruction | | | off | | | | | |
| | | | 0x1: | 0x0 | 0x0 | 0x0 | 0x0 | 0x32 0x01 0x00 0x00 0x00 0x00 |
| | | | turn on | | | | | all devices are turned on |
| Normal | 1-F | 0x3 | 0x0: | 0x0: theme 0 - | 0x0 | 0x0 | 0x0 | 0x43 0x02 0x03 0x00 0x00 0x00 |
| mode setting | | | mode 0 | red | | | | mode 2 and theme 3 are set |
| instruction | | | 0x1: | 0x1: theme 1 - | | | | |
| | | | mode 1 . . . | green | | | | |
| | | | 0x9: | 0x2: theme 2 - | | | | |
| | | | mode | blue . . . | | | | |
| | | | 10 | 0x1C: theme | | | | |
| | | | | 28 - | | | | |
| | | | | multicolor | | | | |
| SHOW mode | 1-F | 0x4 | 0x0: | 0x0: theme 0 - | 0x0 | 0x0 | 0x0 | 0x54 0x01 0x008 0x00 0x00 |
| setting | | | mode 0 | Christmas | | | | 0x00 SHOW mode 1 and |
| instruction | | | 0x1: | 0x1: theme 1 - | | | | Christmas theme are set |
| | | | mode 1 | Valentine's | | | | |
| | | | 0x2: | Day | | | | |
| | | | mode 2 | 0x2: theme 2 - | | | | |
| | | | | Independence | | | | |
| | | | | Day . . . | | | | |
| | | | | 0x08: theme | | | | |
| | | | | title 8 - | | | | |
| | | | | multicolor | | | | |
| Timing time | 1-F | 0x5 | 0x0: | hours 0~23 | Minutes | Seconds | 0x0 | 0x65 0x00 0x06 0x0A 0x20 |
| setting | | | real- | | 0~59 | 0~59 | | 0x00 06:10:32 |
| | | | time | | | | | |
| | | | time | | | | | |
| | | | 0x1: | 0x0, 0x2, 0x4, 0x6, | 0x0 | 0x0 | 0x0 | 0x75 0x01 0x02 0x00 0x00 0x00 |
| | | | timing | 0x8 | | | | timing for 2 hours |
| | | | time | | | | | |
| Light string | 1-F | 0x6 | 0x0: | 0x0 | 0x0 | 0x0 | 0x0 | 0x86 0x00 0x00 0x00 0x00 0x00 |
| sorting | | | reset | | | | | reset to restore a disordered state |
| setting | | | 0x1: | Total sorted | 0x0 | 0x0 | 0x0 | 0x96 0x01 0x05 0x00 0x00 0x00 |
| | | | overall | light strings | | | | overall test of sorted light |
| | | | test | 0x1~0x0A | | | | strings, 0x05 represents that |
| | | | | | | | | there are a total of 5 involved |
| | | | | | | | | light strings |
| | | | 0x2: | 0x0 | 0x0 | 0x0 | 0x0 | 0xA6 0x02 0x00 0x00 0x00 |
| | | | single | | | | | 0x00 test of a single light string |
| | | | string | | | | | |
| | | | test | | | | | |
| | | | 0x3: | current order | 0x0 | 0x0 | 0x0 | 0xB6 0x03 0x02 0x00 0x00 |
| | | | sort | 0x1~0x0A | | | | 0x00 Currently ranked 2 in the |
| | | | | | | | | overall sequence positions |
| | | | 0x4: | Total sorted | 0x0 | 0x0 | 0x0 | 0xC6 0x04 0x06 0x00 0x00 |
| | | | store | light strings | | | | 0x00 store the setting, 0x6 |
| | | | | 0x1~0x0A | | | | represents that a total of 6 light |
| | | | | | | | | strings which involve in the |
| | | | | | | | | sorting |

As shown in the example table above, a signaling message is used by an example Bluetooth Christmas light string according to an embodiment of the present disclosure. The light string may be used as a wireless communication device in the embodiment, and a smartphone of a user may be used as, for example, the electronic device in the embodiment. In the embodiment illustrated in Table 1, when there are multiple light strings, the plurality of light strings may constitute a Bluetooth wireless mesh network, and the smartphone of the user may be paired with one of the light strings, so as to manage all the light strings.

For example, through the messages or portions of messages shown in Table 1, the smartphone of the user may query a state of each light string (e.g., through an “online state query” message), may switch the respective light strings (e.g., through an “overall switch instruction” message), may configure a color of each light string (e.g., through a “normal mode setting instruction” message), may configure a flashing mode of each light string (e.g., through a “SHOW mode setting instruction” message), may configure timing of each light string (e.g., through a “timing time setting” message), or may configure an order of various light strings (e.g., through a “light string sorting setting” message), etc. Correspondingly, the light strings may also report their operating states, etc. to the smartphone using a message of a similar form.

In the embodiment shown in Table 1, the high 4 bits of the byte 1 may be transmission identification flag bits, and the low 4 bits of the byte 1 may be instructions. The transmission identification flag bits may be used to distinguish between different instructions, and when two consecutive instructions have the same flag bit, the instructions may automatically be determined as the same instruction and as a result, the latter instruction may be abandoned, and only the first of the instructions with the same flag bit is retained. In addition, the bytes 2-6 refer to contents of the instructions. However, the present disclosure is not limited thereto. In fact, the meaning and/or number of individual bytes may also be customized in other ways as needed.

In addition, the example message shown in Table 1 is, for example, a message on an application layer between the smartphone of the user and the Bluetooth light string, and, therefore, in practical transmissions, it also needs to add a Bluetooth header, etc., before the message, to indicate, for example, a node ID, a type, etc., thereof. For example, the Bluetooth header of the message may be added in the following format:

| | | | | | | | | | |
|---|---|---|---|---|---|---|---|---|---|
| 03 | LOT | M1 | M2 | Byte 0 | Byte 1 | Byte 2 | Byte | Byte 4 | Byte |
| | | | | | | | 3 | | 5 |

wherein, 03 may indicate that the instruction is in a transparent transmission mode, that is, as shown in FIG. 4 or 5, a mode in which the electronic device and the MCU of the wireless communication device communicate through the wireless communication module (or more specifically, the Bluetooth module) of the wireless communication device. In addition, the LOT may indicate a batch number (which may be determined when leaving the factory). M1 and M2 may be model (type) identification bits. For example, there are a total of 16 bits for the two bytes M1 and M2, each bit from 1 to 16 may represent a device, and when data is transmitted to devices with corresponding models, corresponding bits are set to 1, so that a bulk function of the same type of devices can be achieved. Bytes 0 to 5 may be data content which is transparently transmitted. In addition, some of the bytes, a part of the bytes, or a plurality of the bytes may be changed to indicate a node ID. For example, M1 and/or M2 may be set to indicate a node ID instead of a type (model) to implement control of a single node. Alternatively, it is also possible to change M2 only to indicate a node ID so that the same type of devices are indicated by M1, and a certain node is indicated by M1+M2 or is indicated by M2 alone.

In some embodiments, the device type may be a type number indicating a different product, such as “Lamp” indicating a light string, “Switch” indicating a switch, “Dimmer” indicating a dimmer, “Sensor” indicating a sensor, etc. In addition, in some embodiments, the device type may be an indicator for indicating a different product model, such as LT12 indicating a light string of 12 lights, LT24 indicating a light string of 24 lights, RT5 indicating a 5-receptacle patch panel, etc. In this way, by including an ID and/or type in the message, a control device (e.g., the electronic device 100/400/500) may be enabled to determine a node and/or type thereof involved in the received state report message, state reply message, or any other message, and accordingly adjust the maintained node state table.

Thus, the solution for managing a wireless mesh network and the solution for communication in a wireless mesh network according to an embodiment of the present disclosure have been described in detail with reference to FIGS. 1-5. Next, three simple examples of the wireless communication device will be briefly described to facilitate those skilled in the art to intuitively understand the wireless communication device according to embodiments of the present disclosure.

### Example 1—Light String

This example will be described by taking the application of a Bluetooth MESH in a light string as an example. A circuit of the light string may comprise, for example, a power supply module, a Low Dropout linear regulator (LDO) module, a Bluetooth module, a Master Control (MCU) module, an LED light string module, and an LED unit module. The power supply module may be implemented with a 120V alternative current power supply and may become a 120V, or other voltage, direct current power supply through bridge rectification. For example, TV 2216 may be used as an LED power driving IC for providing constant current (60 mA). The LDO module may provide a stable 3.6V operating voltage to the MCU module and the Bluetooth module to prevent poor communication due to power clutter. The Bluetooth module may be implemented with a CSR 1010 chip, which is mainly used to construct a Bluetooth mesh network with other nodes, and establish a communication connection with mobile phones or other devices. In this example, the MCU module may be implemented with an STM8S105K6 chip, or may also be implemented with other types of single chips such as STM8 S003, MC97F6508A etc. This module mainly communicates with the Bluetooth module and controls a display function of the LED light string. The LED light string module may be a high-voltage, e.g., 120V, series light string of 24 lights. The LED unit module is a driving circuit of each LED, which may be implemented with an LX1002 chip, and is used to build a high-voltage series circuit.

After the device is powered on, the Bluetooth module is initialized, may start searching for peripheral Bluetooth devices, and may be connected to an existing network in accordance with a predetermined criterion. For example, in some embodiments, the Bluetooth module may be connected to a first connectable Bluetooth device which is scanned by itself and join a mesh network where the Bluetooth device is located. In some other embodiments, the Bluetooth module may select a Bluetooth device with the highest signal strength among all the Bluetooth devices which are scanned by the Bluetooth module itself and join a mesh network where the Bluetooth device is located. The present disclosure is not limited thereto.

After a mesh network is established, the Bluetooth module may transmit a networking success instruction (e.g., FD FO FE) to the MCU module, and may transmit a power-on instruction (e.g., a state-report message) to the management device (e.g., a Phone APP) at the same time. The mobile phone APP may confirm a network where the Bluetooth device is located and a type of the Bluetooth device according to an ID and/or type included in the state report message after receiving the power-on instruction from the Bluetooth module, and may present the information to a user through a User Interface (UI) of the mobile APP. After receiving the instruction, the MCU module may transmit power-up and state information to the mobile APP through the Bluetooth module, so that state synchronization between the MCU module and the mobile APP is realized.

In addition, the mobile APP may compare a signal strength of a currently connected bridge point with a signal strength of a peripheral device every 5 seconds and replace the bridge point (or the matched node) with a device having the strongest signal in time.

In addition, in the absence of operations, the mobile APP may transmit a device presence confirmation instruction (for example, a state query message) every 10 seconds to ensure that the device currently displayed on the UI is consistent with a number and type of devices actually existing in the network.

### Example 2—Switch

This example will be described by taking application of a Bluetooth MESH in a switch. A circuit of the switch may comprise a power supply module, a Bluetooth module, a main control module, and a switch module. The power supply module may be implemented with a 120V alternating current power supply, is converted into a direct current power supply through half-wave rectification, and is converted into a 12V direct current power supply through, for example, a LNK304PN. A regulator tube HT7536 is used to provide a 3.6V operating voltage required for operations of the MCU module and the Bluetooth module. The Bluetooth module may be implemented with a CSR 1010 chip, which is mainly used to build a Bluetooth network, and establish a communication relationship with mobile phones or other devices. The main control module may be implemented with a STM8S003, or may also be implemented with other types of single machines such as a MC97F6508A. The main control module is mainly used for communication with the Bluetooth module, and controls the switch to turn on or turn off. The switch module may control a relay to turn on or turn off through high and low levels output by a single chip.

The switch module may operate similarly to the above-described light string module, except that a device-type field in a message transmitted by the switch module to the management device may be different. In addition, a message between the switch module and the management device may be a message for controlling the operation of the switch module, as shown in Table 1 above.

### Example 3—Dimmer

This example will be described by taking application of a Bluetooth MESH in a dimmer. A circuit of the dimmer may comprise a power supply module, a Bluetooth module, a master control module, a dimmer module, and a zero-crossing module. The power supply module may be implemented with a 120V alternating current power supply, is converted into a direct current power supply through half-wave rectification, and is converted into a 12V direct current power supply through, for example, a LNK304PN. A regulator tube HT7536 is used to provide a 3.6V operating voltage required for operations of the main control module and the Bluetooth module. The Bluetooth module may be implemented with a CSR 1010 chip, which is mainly used to build a Bluetooth network, and establish a communication relationship with mobile phones or other devices. The main control module may be implemented with a STM8S003, or may also be implemented with other types of single chips such as a MC97F6508A. This module is mainly used for communication with the Bluetooth module, and controls an Si-controlled switch to achieve a dimming function. The dimmer module controls the Si-controlled switch through high and low levels output by the main control module. The zero-crossing module may perform zero-crossing detection on an alternative current signal. After the main control module samples the signal, it may control the Si-controlled switch separately, in positive and negative half cycles of the alternative current, to realize dimming.

The dimmer module may operate similarly to the light string module and/or the switch module described above, except that a device type field in a message transmitted by the dimmer module to the management device may be different. In addition, a message between the dimmer module and the management device may be a message for controlling the operation of the dimmer module, as shown in Table 1 above.

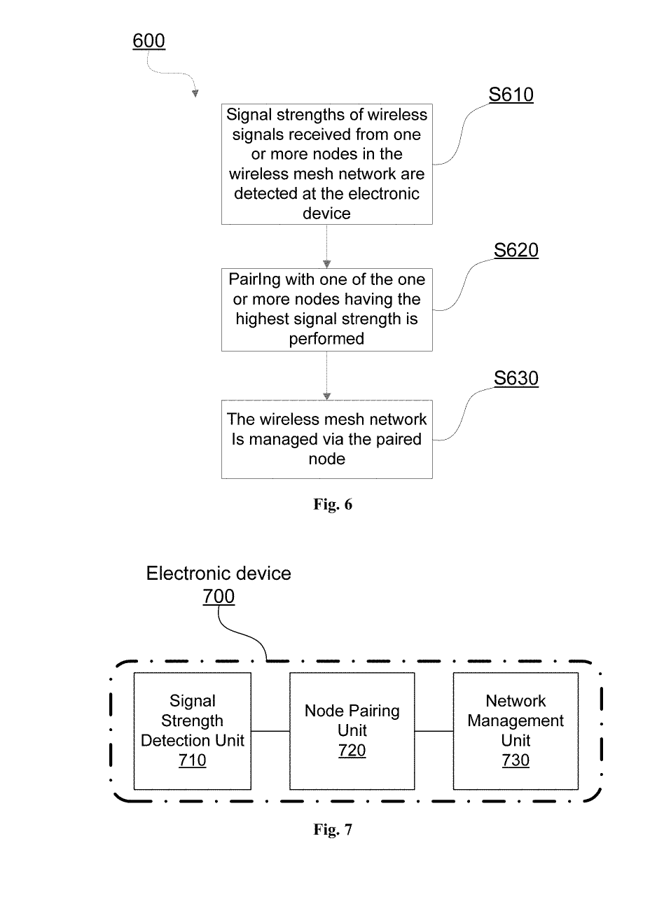

FIG. 6 is a flowchart illustrating a method 600 performed in the electronic device 700 for managing a wireless mesh network according to an embodiment of the present disclosure. As shown in FIG. 6, the method 600 may include steps S610, S620, and S630. According to the present disclosure, some of the steps of the method 600 may be performed individually or in combination, and may be performed in parallel or sequentially, without being limited to a specific order of operations illustrated in FIG. 6. In some embodiments, the method 600 may also be performed by the electronic device 100 and/or the client 101 shown in FIG. 1, the electronic device 200 shown in FIG. 2, the electronic device 400 shown in FIG. 4, and/or the electronic device 500 shown in FIG. 5.

FIG. 7 is a block diagram illustrating an example electronic device 700 for managing a wireless mesh network according to an embodiment of the present disclosure. As shown in FIG. 7, the device 700 may comprise a signal strength detection unit 710, a node pairing unit 720, and a network management unit 730. As described above, these units may be separate hardware units or software modules (e.g., modules of the client 101) executed by the processor(s) of the device 100, 200, 400 and/or 500, or a combination of both.

The signal strength detection unit 710 may be used to detect, at the electronic device, signal strengths of wireless signals received from one or more nodes in the wireless mesh network. For example, the signal strength detection unit 710 may be a CPU, a DSP, a microprocessor, a microcontroller, etc., of the device 700, which may cooperate with a communication portion (e.g., a wireless transceiver etc.) of the device 700 to detect and determine the signal strengths of the wireless signals received from the one or more nodes in the wireless mesh network.

The node pairing unit 720 may be used to perform pairing with one of the one or more nodes having the highest signal strength. For example, the node pairing unit 720 may also be a CPU, a DSP, a microprocessor, a microcontroller, etc., of the device 700, which may cooperate with a communication portion (e.g., a wireless transceiver, etc.) of the device 700, to perform pairing with the selected node, and thus achieve communication with various nodes in the wireless mesh network.

The network management unit 730 may be used to manage the wireless mesh network via the paired node. The network management unit 730 may be a CPU, a DSP, a microprocessor, a microcontroller, etc., of the device 700, which may cooperate with a communication portion (e.g., a wireless transceiver, etc.) of the device 700, to communicate with nodes in the wireless mesh network via the communication portion, so as to control its operation and monitor its operating state.

In addition, the device 700 may further comprise other units not shown in FIG. 7, such as various conventional components for implementing the above and other functions, such as a bus, a power supply, an antenna, etc.

A method 600 performed on the device 700 for managing a wireless mesh network according to an embodiment of the present disclosure and the device 700 will be described in detail below in conjunction with FIG. 6 and FIG. 7.

The method 600 begins at step S610. In step S610, signal strengths of wireless signals received from one or more nodes in the wireless mesh network are detected by the signal strength detection unit 710 of the device 700 at the electronic device 700.

In step S620, pairing with one of the one or more nodes having the highest signal strength is performed by the node pairing unit 702 of the electronic device 700.

In step S630, the wireless mesh network is managed by the network management unit 730 of the electronic device 700 via the paired node.

In some embodiments, the wireless mesh network may be one of a Bluetooth mesh network, a Wi-Fi mesh network, a ZigBee mesh network, or a Z-Wave mesh network, and the electronic device may be paired with the paired node in accordance with a corresponding one of a Bluetooth protocol, a Wi-Fi protocol, a ZigBee protocol, or a Z-Wave protocol. In some embodiments, the method 600 may be performed periodically and/or if a current signal strength for the paired node is lower than a predetermined threshold. In some embodiments, step S630 may comprise: transmitting a state query message to the wireless mesh network via the paired node; and receiving a state reply message of each node from the wireless mesh network via the paired node. In some embodiments, the method 600 further comprises determining whether there is a corresponding record in a node state table maintained by the electronic device based on a node identifier in the state reply message, and, if so, then updating the existing record, otherwise adding a new record. In some embodiments, the method 600 may further comprise: deleting a record for a specific node from the node state table if the specific node does not return a state reply message in response to the state query message within a predetermined time period. In some embodiments, the transmission of the state query message is performed periodically. In some embodiments, step S630 may comprise: receiving a state report message for a specific node from the wireless mesh network via the paired node.

In some embodiments, the method 600 may further comprise: deleting the record for the specific node from a node state table maintained by the electronic device based on a node identifier in the state report message if the state report message indicates that the specific node is powered off, and adding a new record for the specific node into the node state table based on the node identifier in the state report message if the state report message indicates that the specific node is powered on. In some embodiments, step S630 may further comprise: counting a number of nodes of each type in the wireless mesh network based on node type information comprised in a state reply message and/or state report message for each node in the wireless mesh network received via the paired node. In some embodiments, the method 600 may further comprise: providing a user with a user interface on the electronic device for presenting a state of each node in the wireless mesh network and/or for controlling each node in the wireless mesh network.

In some embodiments, at least one node in the wireless mesh network may comprise at least one of: a light string, a switch, a dimmer, a receptacle, a water meter, an electric meter, a gas meter, a valve, an alarm, a sensor, a motor, and/or a camera.

In some embodiments, if the pairing with the node having the highest signal strength fails, then the electronic device may attempt to pair with one of the other nodes having the highest signal strength and the process is repeated until a successful pairing. In some embodiments, step S630 may further comprise: for multiple nodes in the wireless mesh network, transmitting messages to the multiple nodes via the paired node, respectively, to make the multiple nodes operate in a cooperative manner. In some embodiments, making the multiple nodes operate in a cooperative manner may comprise at least one of: making the multiple nodes operate in an order specified by the electronic device; and/or making the multiple nodes operate concurrently.

In some embodiments, step S620 may further comprise: initiating a pairing request to the node having the highest signal strength with a default passcode or a user configured passcode; and receiving a response indicating a successful pairing from the node if the passcode is correct. In some embodiments, if one or more nodes of the wireless mesh network except the paired node are paired with another electronic device, then the wireless mesh network is jointly managed by the electronic device and the other electronic device.

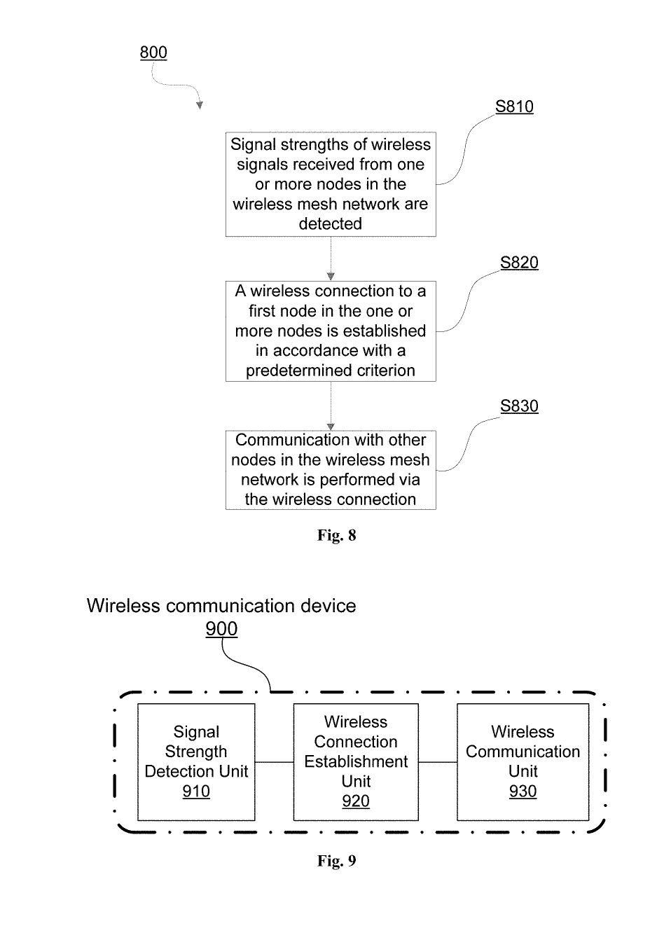

FIG. 8 is a flowchart illustrating a method 800 performed in a wireless communication device 900 for communication in a wireless mesh network according to an embodiment of the present disclosure. As shown in FIG. 8, the method 800 may comprise steps S810, S820, and S830. According to the present disclosure, some of the steps of the method 800 may be performed individually or in combination, and may be performed in parallel or sequentially, without being limited to a specific order of operations illustrated in FIG. 8. In some embodiments, the method 800 may also be performed by the wireless communication device 110 shown in FIG. 1, the wireless communication device 300 shown in FIG. 3, the wireless communication device 410 shown in FIG. 4, and/or the wireless communication device 510 shown in FIG. 5.

FIG. 9 is a block diagram illustrating an example electronic device 900 for communication in a wireless mesh network according to an embodiment of the present disclosure. As shown in FIG. 9, the device 900 may comprise a signal strength detection unit 910, a wireless connection establishment unit 920, and a wireless communication unit 930. As described above, the units may be separate hardware units, or software modules executed by the processor(s) of the devices 110, 300, 410 and/or 510, or a combination of both.

The signal strength detection unit 910 may be used to detect signal strengths of wireless signals received from one or more nodes in the wireless mesh network. For example, the signal strength detection unit 910 may be a CPU, a DSP, a microprocessor, a microcontroller, etc., of the device 900, which may cooperate with a communication portion (e.g., a wireless transceiver, etc.) of the device 900 to detect and determine the signal strengths of the wireless signals received from the one or more nodes in the wireless mesh network.

The wireless connection establishment unit 920 may be used to establish a wireless connection with a first node in one or more nodes in accordance with a predetermined criterion. For example, the wireless connection establishment unit 920 may also be a CPU, a DSP, a microprocessor, a microcontroller, etc., of the device 900, which may cooperate with a communication portion (e.g., a wireless transceiver, etc.) of the device 900, to select the first node to be connected according to the predetermined criterion, establish a connection with the selected first node, and thereby implement communication with each node in the wireless mesh network.

The wireless communication unit 930 may be used to communicate with other nodes in the wireless mesh network via the wireless connection. The wireless communication unit 930 may be a CPU, a DSP, a microprocessor, a microcontroller, etc., of the device 900, which may cooperate with a communication portion (e.g., a wireless transceiver, etc.) of the device 900, to communicate with other nodes and/or control devices in the wireless mesh network via the communication portion, so as to report an operating state and/or receive an operation instruction, etc.

In addition, the device 900 may further comprise other units not shown in FIG. 9, such as various conventional components for implementing the above and other functions, such as a bus, a power supply, an antenna etc.

A method 800 performed on the device 900 for communication in a wireless mesh network according to an embodiment of the present disclosure and the device 900 will be described in detail below in conjunction with FIG. 8 and FIG. 9.

The method 800 begins at step S810. In step S810, signal strengths of wireless signals received from one or more nodes in the wireless mesh network may be detected by the signal strength detection unit 910 of the device 900 at the electronic device 900.

In step S820, a wireless connection to a first node in one or more nodes may be established by the wireless connection establishment unit 920 of the device 900 in accordance with a predetermined criterion.

In step S830, the wireless communication unit 930 of the device 900 may communicate with other nodes in the wireless mesh network via the wireless connection.

In some embodiments, the wireless mesh network may be one of a Bluetooth mesh network, a Wi-Fi mesh network, a ZigBee mesh network, or a Z-Wave mesh network, and the wireless communication device may be a corresponding one of a Bluetooth communication device, a Wi-Fi communication device, a ZigBee communication device, or a Z-Wave communication device. In some embodiments, the predetermined criterion may be at least one of: the first node detected in a chronological order; and/or the detected node having the highest signal strength. In some embodiments, the method 800 may further comprise: storing information for other nodes of the one or more nodes than the first node as alternative nodes. In some embodiments, step S830 may comprise: receiving a state query message from the wireless mesh network via the wireless connection; and transmitting a state reply message to the wireless mesh network via the wireless connection based on a configuration and/or state of the wireless communication device. In some embodiments, step S830 may comprise: transmitting a state report message to the wireless mesh network via the wireless connection. In some embodiments, the state report message and/or the state reply message comprise at least a node identifier and/or node type of the wireless communication device.

In some embodiments, the wireless communication device may comprise at least one of: a light string, a switch, a dimmer, a receptacle, a water meter, an electric meter, a gas meter, a valve, an alarm, a sensor, a motor, and/or a camera.

In some embodiments, if the establishment of the wireless connection with the first node fails, then the wireless communication device may attempt to establish a wireless connection with a second node of the other nodes which meets the predetermined criterion and the process is repeated until a wireless connection is established successfully. In some embodiments, step S820 may further comprise: initiating a connection request to the first node with a default passcode or a user configured passcode; and receiving a response indicating a successful connection from the first node if the passcode is correct. In some embodiments, the method 800 may further comprise: establishing a paired connection with an electronic device outside of the wireless mesh network.

In some embodiments, the method 800 may further comprise: receiving a state query message from the electronic device via the paired connection; and transmitting a state reply message to the electronic device via the paired connection based on a configuration and/or state of the wireless communication device. In some embodiments, the method 800 may further comprise: forwarding the state query message to other nodes in the wireless mesh network via the wireless connection; receiving state reply messages from the other nodes in the wireless mesh network via the wireless connection; and forwarding the state reply messages for the other nodes to the electronic device via the paired connection.

In some embodiments, the method 800 may further comprise: transmitting a state report message to the electronic device via the paired connection. In some embodiments, the method 800 may further comprise: receiving state report messages from other nodes in the wireless mesh network via the wireless connection; and forwarding the state report messages for other nodes to the electronic device via the paired connection.

The present disclosure has thus far been described in connection with certain embodiments. It is to be understood that various other changes, substitutions and additions can be made by those skilled in the art without departing from the spirit and scope of the present disclosure. For example, different technical features in different embodiments can be combined to form a new embodiment. Accordingly, the scope of the present disclosure is not limited to the specific embodiments described above, but should be defined by the appended claims.

In addition, functions described herein as being implemented by only hardware, only software, and/or only firmware can also be implemented by means of dedicated hardware, a combination of general purpose hardware and software, etc. For example, functions described as being implemented by dedicated hardware (e.g., a Field Programmable Gate Array (FPGA), an Application Specific Integrated Circuit (ASIC), etc.) can be implemented by general purpose hardware (e.g., a Central Processing Unit (CPU), a Digital Signal Processor (DSP)) in combination with software, and vice versa.

1. A method performed at an electronic device for managing a wireless mesh network, the method comprising:
detecting, at the electronic device, signal strengths of wireless signals received from one or more nodes in the wireless mesh network;
pairing with one of the one or more nodes having the highest signal strength; and
managing the wireless mesh network via the paired node.

2. The method according to claim 1, wherein the wireless mesh network is one of a Bluetooth mesh network, a Wi-Fi mesh network, a ZigBee mesh network, or a Z-Wave mesh network, and the electronic device is paired with the paired node in accordance with a corresponding one of a Bluetooth protocol, a Wi-Fi protocol, a ZigBee protocol, or a Z-Wave protocol.

3. The method according to claim 1, wherein the method is performed periodically and/or if a current signal strength for the paired node is lower than a predetermined threshold.

4. The method according to claim 1, wherein the step of managing the wireless mesh network via the paired node comprises the steps of:
transmitting a state query message to the wireless mesh network via the paired node; and
receiving a state reply message of each node from the wireless mesh network via the paired node.

5. The method according to claim 4, further comprising:
determining whether there is a corresponding record in a node state table maintained by the electronic device based on a node identifier in the state reply message; and,
if so, then updating the existing record, otherwise adding a new record.

6. The method according to claim 5, further comprising:
deleting a record for a specific node from the node state table if the specific node does not return a state reply message in response to the state query message within a predetermined time period.

7. The method according to claim 4, wherein the transmission of the state query message is performed periodically.

8. The method according to claim 1, wherein the step of managing the wireless mesh network via the paired node comprises the steps of:
receiving a state report message for a specific node from the wireless mesh network via the paired node.

9. The method according to claim 8, further comprising:
deleting the record for the specific node from a node state table maintained by the electronic device based on a node identifier in the state report message if the state report message indicates that the specific node is powered off; and
adding a new record for the specific node into the node state table based on the node identifier in the state report message if the state report message indicates that the specific node is powered on.

10. The method according to claim 1, wherein the step of managing the wireless mesh network via the paired node comprises the steps of:
counting the number of nodes of each type in the wireless mesh network based on node type information comprised in a state reply message and/or state report message for each node in the wireless mesh network received via the paired node.

11. The method according to claim 1, further comprising:
providing a user with a user interface on the electronic device for presenting a state of each node in the wireless mesh network and/or for controlling each node in the wireless mesh network.

12. The method according to claim 1, wherein at least one node in the wireless mesh network comprises at least one of: a light string, a switch, a dimmer, a receptacle, a water meter, an electric meter, a gas meter, a valve, an alarm, a sensor, a motor, and/or a camera.

13. The method according to claim 1, wherein if the pairing with the node having the highest signal strength fails, then the electronic device attempts to pair with one of the other nodes having the highest signal strength and the process is repeated until a successful pairing.

14. The method according to claim 1, wherein the step of managing the wireless mesh network via the paired node comprises the steps of:
for multiple nodes in the wireless mesh network, transmitting messages to the multiple nodes via the paired node, respectively, to make the multiple nodes operate in a cooperative manner.

15. The method according to claim 14, wherein making the multiple nodes operate in a cooperative manner comprises at least one of:
making the multiple nodes operate in an order specified by the electronic device; and/or
making the multiple nodes operate concurrently.

16. The method according to claim 1, wherein the step of pairing with one of the one or more nodes having the highest signal strength comprises the steps of:
initiating a pairing request to the node having the highest signal strength with a default passcode or a user configured passcode; and
receiving a response indicating a successful pairing from the node if the passcode is correct.

17. The method according to claim 1, wherein if one or more nodes of the wireless mesh network except the paired node are paired with another electronic device, then the wireless mesh network is jointly managed by the electronic device and the other electronic device.

18. (canceled)

19. An electronic device, comprising:
a processor;
a wireless communication module;
a memory storing instructions which, when executed by the processor, cause the processor to:
determine signal strengths of wireless signals received through the wireless communication module from one or more nodes in the wireless mesh network;
instruct the wireless communication module to pair with one of the one or more nodes having the highest signal strength; and
manage the wireless mesh network via the paired node through the wireless communication module.

20. A communication method performed at a wireless communication device in a wireless mesh network, the method comprising:
detecting signal strengths of wireless signals received from one or more nodes in the wireless mesh network;
establishing a wireless connection to a first node in the one or more nodes in accordance with a predetermined criterion; and
communicating with other nodes in the wireless mesh network via the wireless connection.

21. (canceled)

22. The method according to claim 20, wherein the predetermined criterion is at least one of:
the first node detected in a chronological order; and/or
the detected node having the highest signal strength.

23.-39. (canceled)
